(19) United States
(12) Patent Application Publication
(10) Pub. No.: US 2005/0083694 A1
(43) Pub. Date: Apr. 21, 2005

(54) Disposable lighting fixture with a fluorescent light source

(76) Inventor: Paolo Targetti, Florence (IT)

Correspondence Address: STEINBERG & RASKIN, P.C., 1140 AVENUE OF THE AMERICAS, 15th FLOOR, NEW YORK, NY, 10036-5803, US

(21) Appl. No.: 10/505,634

(22) PCT Filed: Dec. 18, 2003
(86) PCT No.: PCT/IT03/00834

(30) Foreign Application Priority Data
Dec. 20, 2002 (IT) FI2002U000114

(51) Int. Cl. F21K 2/00

(52) U.S. Cl. 362/260

(57) ABSTRACT

A lighting fixture with a fluorescent light source, comprising a base (1) with at least one fluorescent lighting element (2) extending integrally therewith and an electronic system (3) for controlling the operation of the fixture arranged below the base and capable of being connected to a power supply network. The base (1) extends on the same side as the lighting element (2) to form a casing (4) around it acting as a reflector for the lighting element (2).

### FIELD OF THE INVENTION

The present invention generally relates to lighting apparatuses and more particularly relates to a disposable lighting fixture incorporating a light source of the fluorescent type.

### BACKGROUND OF THE INVENTION

Currently available lighting fixtures comprise a light source or light-bulb and a bulb holder by means of which the light-bulb is connected to the power supply. The bulb holder is associated with or incorporated in a support that, as a general rule, also has aesthetic functions. Apart from the destination of the lighting fixture (table lamp, wall lamp, ceiling lamp or downlight lamp), proper functioning of the lighting fixture is maintained by replacing the bulb every time it burns out, keeping the bulb holder in its position.

This approach has always been adopted with conventional incandescent light-bulbs without giving rise to any particular drawbacks. Following the spread of fluorescent light-bulbs, also known as electronic bulbs, of which both the useful life and the cost is substantially greater, it has been found that in certain circumstances this solution may prove not to be convenient. This is the case, for example, of temporary lighting networks of buildings under construction that are realized with downlight lighting fixtures employing electronic light-bulbs. These lighting fixtures are destined to be dismantled when the building is consigned to its owner and the light-bulbs are recovered. As a general rule, in these cases the bulb-holder is not dismantled and is subsequently eliminated when the rooms are to be furnished. Similar problems are encountered also when fair stands and the like have to be prepared. These problems derive substantially from the fact that the long life of the electronic bulbs and their high cost justify their being recovered, since, unlike the bulb holders, which are not recovered, they can then be re-used in other circumstances.

### OBJECTS AND SUMMARY OF THE INVENTION

The object of the present invention is to provide a lighting fixture with an incorporated and integral fluorescent light source that will be low-cost, practical and capable of being quickly installed and removed.

Another object of the present invention is to provide a lighting fixture of the aforementioned type having a configuration such as to make it possible and economically advantageous to replace the entire apparatus rather than just the light-bulb and leaving the bulb holder installed, as is done in accordance with common practice.

These objects are attained with the lighting fixture with a fluorescent light source in accordance with the present invention, which comprises a base from which there extends at least one fluorescent lighting element, an electronic system for controlling the functioning of the apparatus arranged on said base and capable of being connected to an electricity supply network, and is characterized in that the base extends on the same side as the lighting element to form a casing around it acting as a reflector for the lighting element.

In this way, since the lighting element is integral with the base, rather than carrying out the operations of replacing the bulb and maintaining the support or bulb holder in position, as usual, the entire apparatus will be replaced by simply carrying out the operations of disconnection and re-wiring. In other words, instead of replacing the bulb, the lighting fixture is replaced in its entirety, because the lighting fixture in accordance with the invention is complete in itself and does not need additional components such as a light source.

### BRIEF DESCRIPTION OF THE DRAWINGS

The invention will now be illustrated in greater detail by the following description of an embodiment thereof, which is given by way of example and is not to be considered limitative in any way, the description making reference to the attached drawings, of which:

FIG. 1 shows a front perspective view of the lighting fixture in accordance with the present invention;

FIG. 2 shows a rear perspective view of the lighting fixture of FIG. 1;

FIG. 3 is a side elevational view of the lighting fixture in accordance with the invention;

FIG. 4 is a front elevational view of the lighting fixture; and

FIG. 5 is a rear perspective view of the lighting fixture with some parts removed for greater clarity.

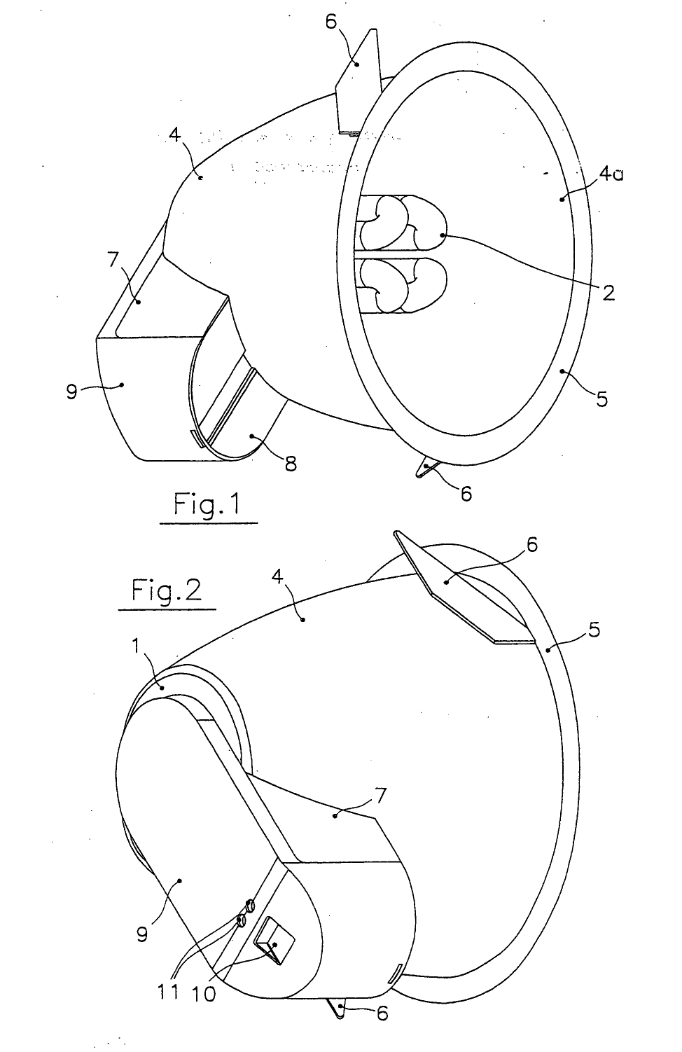

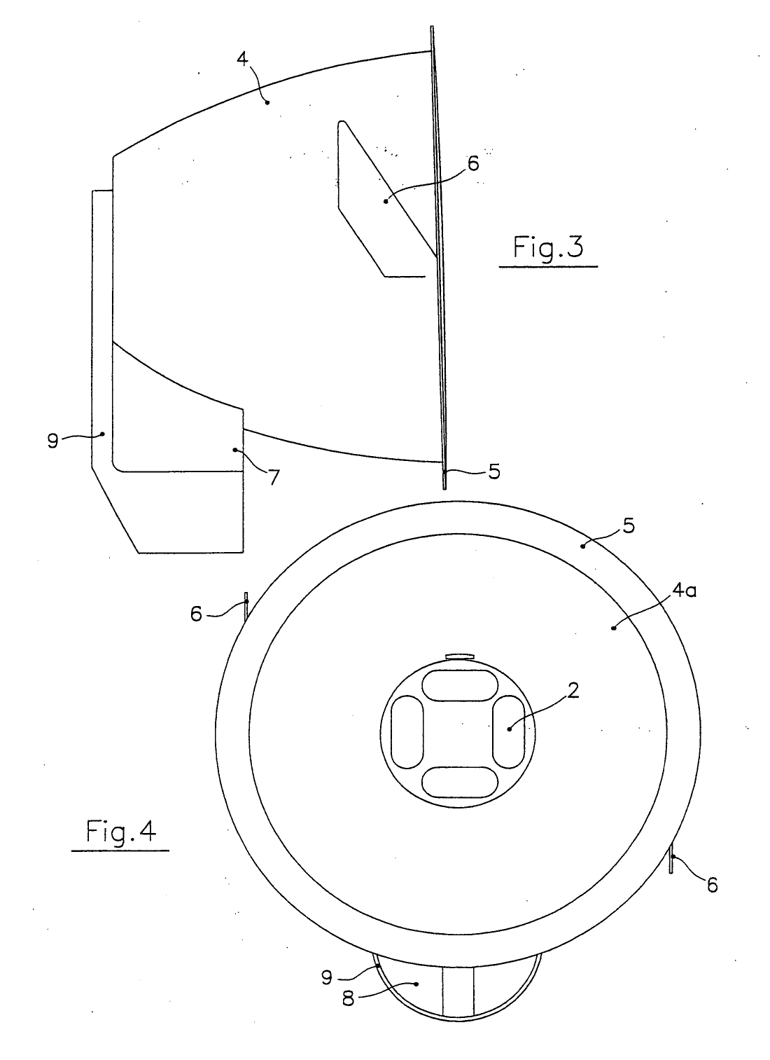

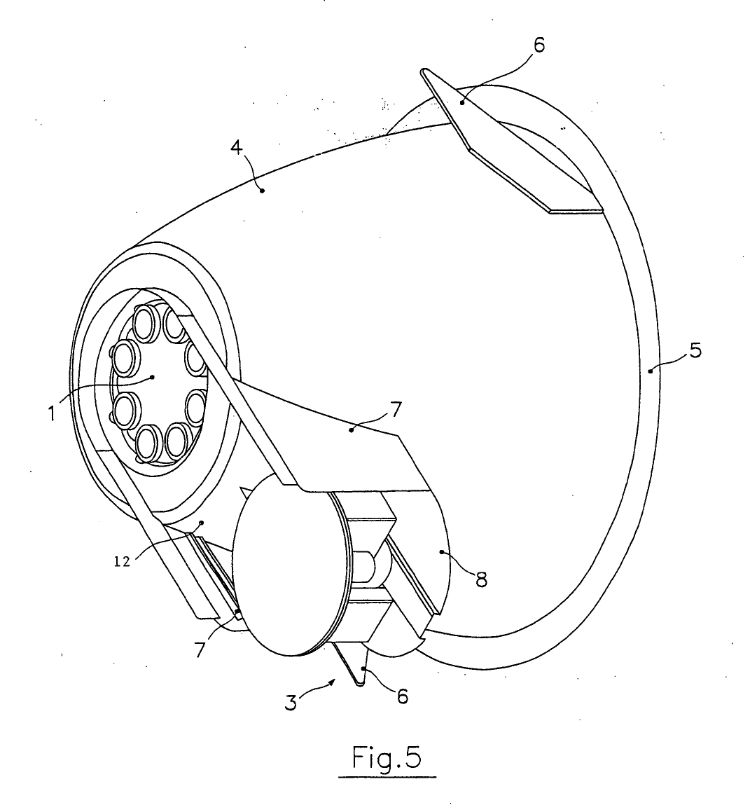

### DETAILED DESCRIPTION OF THE INVENTION

Referring to the aforesaid figures, the lighting fixture in accordance with the invention comprises a flat base 1 with a fluorescent lighting element in the form of fluorescent tubes 2 of a conventional type extending from one side thereof and projecting from the other face of base 1, where there is provided the electronic system of the lamp, schematically illustrated in FIG. 5 and generally indicated by the reference number 3. The fluorescent tubes are integrally fixed to base 1 and cannot be separated therefrom. On the side of fluorescent tubes 2 base 1 extends from its periphery to form a casing 4 having substantially the shape of a cup extending around the fluorescent tubes 4. The internal face 4a of casing 4 therefore constitutes the reflector for fluorescent tubes 2. Casing 4 terminates with an outwardly projecting edge 5 forming a stop element for abutting with the panel into which the apparatus is to be housed. With a view to locking the light fixture in its housing position, on casing 4 there are provided elastic fins 6 that can be used, in a conventional manner, as elements for securing the fixture to the panel.

With respect to the base, the electronic system is not arranged in a position axially opposite to the fluorescent tubular elements as in conventional fluorescent lamps, but is housed in a chamber 12 axially displaced with respect to the tubular elements 2 and formed on the side of the casing 4 between two walls 7 extending at right angles from base 1, the chamber being closed on the front side by a transverse wall 8. Chamber 6 extends up to the base 1 to permit the electrical connections and is closed by a lid 9 of the snap-on type at its rear side. A window 10 is formed on lid 9 to permit, for example, the insertion of a plug fitted to the end of a supply cable or the passage of the supply cable to be fixed to an internal quick-connection terminal board by pressing the appropriate spring by means of a tool to be inserted in holes 11 formed on cover 9.

The lighting fixture in accordance with the invention can be used also for applications other than downlighters, such as suspended lighting fixtures, ceiling lights, wall and table lamps, an adapter accessory of shape appropriate for the specific application being only required. For example, a bracket-shaped hook-on accessory with adapter will make it possible to use the apparatus as a lamp to be attached to a rail, while an accessory for hooking onto a bracket and allowing the apparatus to be orientated can make it function as a projector. Yet another accessory of a suitable shape to permit the apparatus being grasped with a hand will enable the lighting fixture in accordance with the invention being used as a torch.

The shape of the casing illustrated in the figures is intended simply as an example and can be varied according to need and particular design choices.

1. A lighting fixture with a fluorescent light source, comprising a base with at least one fluorescent lighting element extending therefrom and incorporated integrally therewith, an electronic system for controlling operation of the fixture arranged below the base for connection to a power supply network, wherein the base extends on the same side as and around the at least one lighting element in the form of a casing and, thereby serve as a reflector for the lighting element.

2. The fixture set forth in claim 1, wherein the electronic system is arranged at the side of the casing in a position displaced relative to the axis of the at least one lighting element, in a chamber delimited by walls extending from the casing and by a closing lid.

3. The fixture set forth in claim 1, wherein the casing includes a chamber for securing the fixture to a housing surface.

4. The fixture set forth in claim 1, further comprising an adapter for use in suspended fittings, ceiling lights, wall and table lamps, projectors, torches, and on rails.

5. The fixture set forth in claim 1, wherein the at least one lighting element is mounted to the base and is non-replaceable.
